(19) United States
(12) Patent Application Publication
(10) Pub. No.: US 2011/0119454 A1
(43) Pub. Date: May 19, 2011

(54) DISPLAY SYSTEM FOR SIMULTANEOUS DISPLAYING OF WINDOWS GENERATED BY MULTIPLE WINDOW SYSTEMS BELONGING TO THE SAME COMPUTER PLATFORM

(76) Inventors: Hsiang-Tsung KUNG, Taipei City (TW); Teng-Chang CHANG, Taipei City (TW); Shao-Hsuan KAO, Taoyuan City (TW)

(21) Appl. No.: 12/620,319

(22) Filed: Nov. 17, 2009

(51) Int. Cl. G06F 12/00; G06F 3/048

(52) U.S. Cl. 711/150; 715/806; 711/E12.001

(57) ABSTRACT

A display system for simultaneous displaying of windows generated by a plurality of window systems belonging to the same desktop or laptop platform includes a master computer device with its display device and at least one slave computer device, a shared memory, an input means and an output means, as described herein. Each of the master computer device and the at least one slave computer device has a corresponding window system. The shared memory is coupled to the computer devices and is accessible by the master computer device and the at least one slave computer device. The input means receives multiple windows simultaneously generated by the window systems of the master computer device and the at least one slave computer device. The output means generates the multiple windows for the display device of the master computer device. In support of these operations, the master computer device and the at least one slave computer device simultaneously read and write window data stored in the shared memory.

### BACKGROUND OF THE INVENTION

1. Field of the Invention

The disclosure relates generally to display systems and display methods thereof, for simultaneous displaying of windows generated by multiple window systems of a plurality of computer devices belonging to the same desktop or laptop platform on the display device of one of these computer devices.

2. Description of the Related Art

Today it is common for a computer device to display multiple windows simultaneously thereon. The user may delete information from a window, move data from one window to another, and generally operate on any window at any time. Driven by user requirements, multiple windows from different window systems running on different computer devices may be required for their display on the same computer device for user convenience.

Generally, window data from multiple computer devices may be displayed on a display device of a single computer device. For example, with the Virtual Network Computing (VNC) system, windows generated by multiple networked computer devices can be displayed on a display device of one of these devices. The VNC, however, requires the use of a predefined network protocol between the computer devices and a network connecting these devices. For displaying of windows generated by window systems of multiple computer devices belonging to the same desktop or laptop platform, however, it is not possible to use the VNC, because VNC works on networked devices rather than devices on shared system buses. These desktop or laptop platforms which consist of multiple devices have some important advantages. For example, such a platform consisting of both x86- and ARM-based computer devices can generally use the ARM CPU to reduce power consumption, while still being able to run x86 applications by using the x86 CPU. Note that these computer devices each have their own window systems. Prior to this invention, there were no display systems capable of simultaneous displaying windows generated by a plurality of window systems on the same desktop or laptop platform.

### BRIEF SUMMARY OF THE INVENTION

It is therefore an objective to provide display systems and methods for simultaneous displaying of windows generated by multiple window systems of a plurality of computer devices belonging to the same desktop or laptop platform.

An embodiment of a display system for simultaneous displaying of windows generated by multiple window systems comprises a master computer device with a display device, at least one slave computer device, a shared memory, an input means and an output means, as described herein. Each of the master computer device and the at least one slave computer device has a corresponding window system. The shared memory is coupled to the master computer device and the at least one slave computer device. The input means receives multiple windows simultaneously generated by the window systems of the master computer device and the at least one slave computer device. The output means displays the multiple windows on the display device of the master computer device, wherein the master computer device and the at least one slave computer device simultaneously read and write window data stored in the shared memory.

In one embodiment, a display method for simultaneous displaying of windows generated by the window system of a master computer device and that of at least one slave computer device in a display device of the master computer device is provided, wherein the display system includes the master computer device with a display device, the at least one slave computer device and a shared memory accessible by the master computer device and the at least one slave computer device. The method comprises: storing window data of the at least one slave computer device to the shared memory; obtaining the window data of the slave computer device from the shared memory by the master computer device; and merging all of the obtained window data to generate a composite window data, wherein the composite window data is displayed on the display device by the master computer device.

In another embodiment, a display method for simultaneous displaying of windows in a display system comprising a master computer device with a display device and a corresponding window system, at least one slave computer device with a corresponding window system and a shared memory. The method comprises the following steps. First, an activation signal for activating an application of the at least one slave computer device is received by the master computer device. Thereafter, the application is performed on the at least one slave computer device to create window data of the application, wherein the window data of the application is written to the shared memory by the window system of the at least one slave computer device. Next, the window data of the application is obtained by the master computer device from the shared memory, a composition for a current window data and the obtained window data is performed by the master computer device to generate a composite window data which is then displayed on the display device by the window system of the master computer device.

Display methods and systems may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a display system of the invention;

FIG. 2 illustrates an embodiment of a shared-memory of the invention;

FIGS. 3A and 3B illustrate embodiments of look-up tables used by the window location system of the invention;

FIG. 4 illustrates an embodiment of a user interface of the invention;

FIG. 5 is a flowchart of an embodiment of a display method for activating an application running on the at least one slave computer device from the master computer device of the invention;

FIG. 6 is a flowchart of another embodiment of a display method for displaying multiple windows simultaneously generated by the master computer device and the at least one slave computer device in a display device of a display system of the invention;

FIG. 7 is a flowchart illustrating an embodiment of a method for accessing the shared memory for the master computer device of the invention; and

FIG. 8 is a schematic diagram illustrating an embodiment of a window composition operation of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

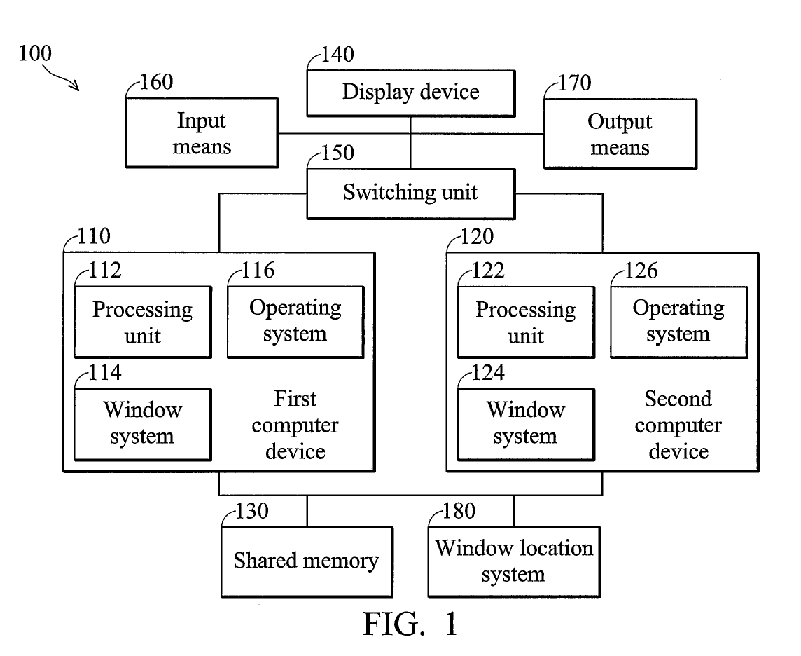

FIG. 1 is a schematic diagram illustrating an embodiment of a display system 100 of the invention. The display system 100 at least comprises two or more computer devices 110 and 120, a shard memory 130, a display device 140, a switching unit 150, an input means 160 and an output means 170. Each computer device may further comprise a processing unit for controlling and computing operation of the computer device, a window system used in the computer device and an operating system (OS) running the window system. Note that the window system may further comprise a window manager for handling the display of the window data. For example, as shown in FIG. 1, the computer device 110 may comprise a processing unit 112 for controlling and computing operation of the computer device 110, a window system 114 used in the computer device 110 and an operating system 116 running the window system 114. The computer device 120 may comprise a processing unit 122, a window system 124 used in the computer device 120 and an operating system 126 running the window system 124. In one embodiment, the computer devices 110 and 120 may have processing units with the same processing unit type and window system running on the same OS, such as the x86 series CPU (central controlling unit) processing unit type and the Microsoft™ Windows-based window operating system. In another embodiment, the display system 100 may comprise a plurality of heterogeneous computer devices on the same platform. For example, the computer devices 110 and 120 may have processing units with different processing unit types and/or different window systems running on different OSes. For example, the processing unit type of the computer device 110 may be the x86 series CPU and the processing unit type of the computer device 120 may be an ARM processor. Also, the type of the window system 114 of the computer device 110 may be a Microsoft™ Window-based window system while the type of the window system 124 of the computer device 120 may be a Linux-based window system.

The shared memory 130 is coupled to and accessible by the computer devices 110 and 120. The computer devices 110 and 120 may connect to the shared-memory 130 through a connection interface. The connection interface may be, for example, any kind of bus device such as a PCI-E bus device. The computer device which controls the display of the display device 140 (e.g., an LCD display) is referred to as a master computer device and the at least one other computer device is referred to as the slave computer device. For example, in this embodiment, as the computer device 110 directly controls the display of the display device 140, the computer device 110 is referred to as the master computer device while the computer device 120 is referred to as the at least one slave computer device hereinafter. Note that the computer device 120 may directly control the display of the display device 140 and thus it is referred to as the master computer device while the computer device 110 is referred to as the at least one slave computer device in another embodiment. The at least one slave computer device 120 may write window data to the shared-memory 130 and the master computer device 110 may read the window data from the shared-memory 130 simultaneously.

The switching unit 150 is connected between the computer devices 110 and 120 and the display device 140 to selectively display the screen of the computer device 110 or the computer device 120 on the display device 140 according to a master selection for selecting which computer device to be the master computer device. For example, the screen of the computer device 110 will be displayed on the display device 140 if a mater selection indicating that the computer device 110 is set to be the master computer device is received by the switching unit 150. The input means 160 is coupled to the master computer device 110 and the at least one slave computer device 120 to receive multiple windows simultaneously generated by the window systems of the master computer device 110 and the at least one slave computer device 120. The output means 170 is used for generating and displaying the multiple windows on the display device 140. The inputs means 160 and the output means 170 may be implemented by hardware, software or a combination thereof and are well known in the art, thus detailed description is omitted here.

The shared memory 130 may be divided into memory modules with the same or different memory sizes. Thus, the shared memory 130 may further comprise a number of memory modules, each of which with a corresponding memory controller. Each memory module may be independently accessed by its own memory controller so that the shared memory may support simultaneous reading and writing of data in the memory modules via multiple memory controllers. It is to be understood that the shared memory 130 may be any type of accessible memory structure. In one embodiment, the shared memory may be a set of linked memory modules together with a management system for identifying the next memory module to write or read. For example, the shared memory 130 may be a ring buffer memory with a management system for processing linked data files to identify a next memory module to write, but it is not limited thereto. In one embodiment, for example, the size of each memory module may be determined based on a maximum window size used in the window systems 114 and 124. For example, if the maximum window size used in the window systems 114 and 124 is a resolution of 1024*768 with 32 bit color depth, the size of each memory module may be defined as 1024*768*32 bits=3M bytes. As the size of each memory module is determined to be the maximum window size supported by all of the window systems, each window data of each of the window systems can be written into or read from just one of the memory modules.

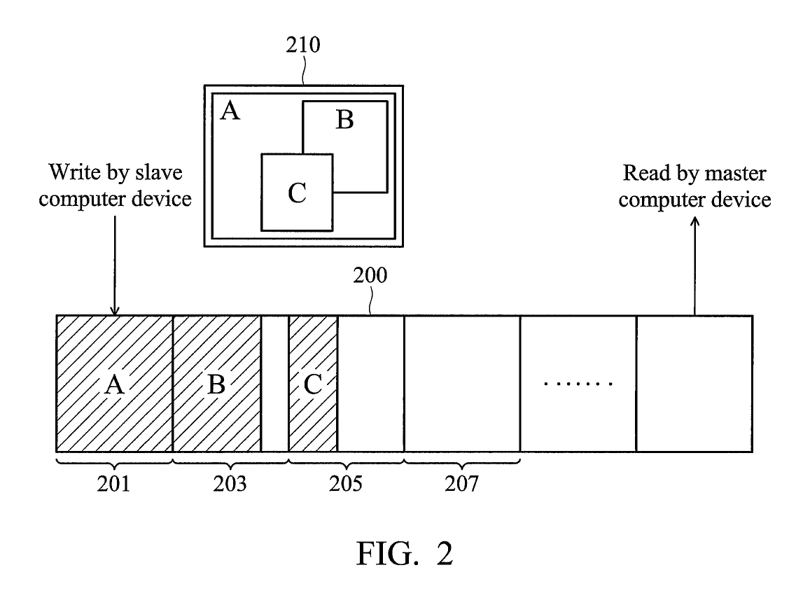

FIG. 2 illustrates an embodiment of a shared-memory 200 of the invention. In one embodiment, as shown in FIG. 2, the shared-memory 200 is divided into several memory modules with the same size. Three of these memory modules contain window data for the three windows A, B and C shown on a desktop 210 of the master computer device 110, one module for each window. Referring to FIG. 2, the desktop 210 represents a desktop screen of the master computer device 110, which is produced by the window system 124 of the computer device 120. As the maximum window size among the three windows A, B and C on the desktop 210 is that of a window with a resolution of 1024×768 with 32-bit color depth, the size of each memory module is defined as 3M bytes. Therefore, window data of the windows A, B, C may be written into memory modules 201, 203 and 205, respectively, although the size of the window data of the windows B and C are less than the size of the memory module. The at least one slave computer device 120 may generate the window data of each window on the desktop 210 and write them into the shared memory 130. The master computer device 110 may read the window data of the windows from the shared memory 130.

The shared memory 130 may further be associated with a window location system 180 which maps a given window to one of the memory modules containing window data of the given window. In addition, the window location system 180 is capable of providing access control for the shared memory 130.

The window location system 180 may comprise a cache memory capable of reading/writing by multiple computer devices (e.g., the master and slave computer devices) and. The window location system 180 may further have, for example, a look-up table with a recorded status of each module, e.g., whether a memory module is available or not, its corresponding memory address and information on content stored in the memory module. The look-up table may be stored in the cache memory such that the window location system 180 may, therefore, utilize the look-up table to obtain a memory address of a given window to map the given window to one of the memory modules containing window data of the given window when data is to be read from or written into the shared memory 130.

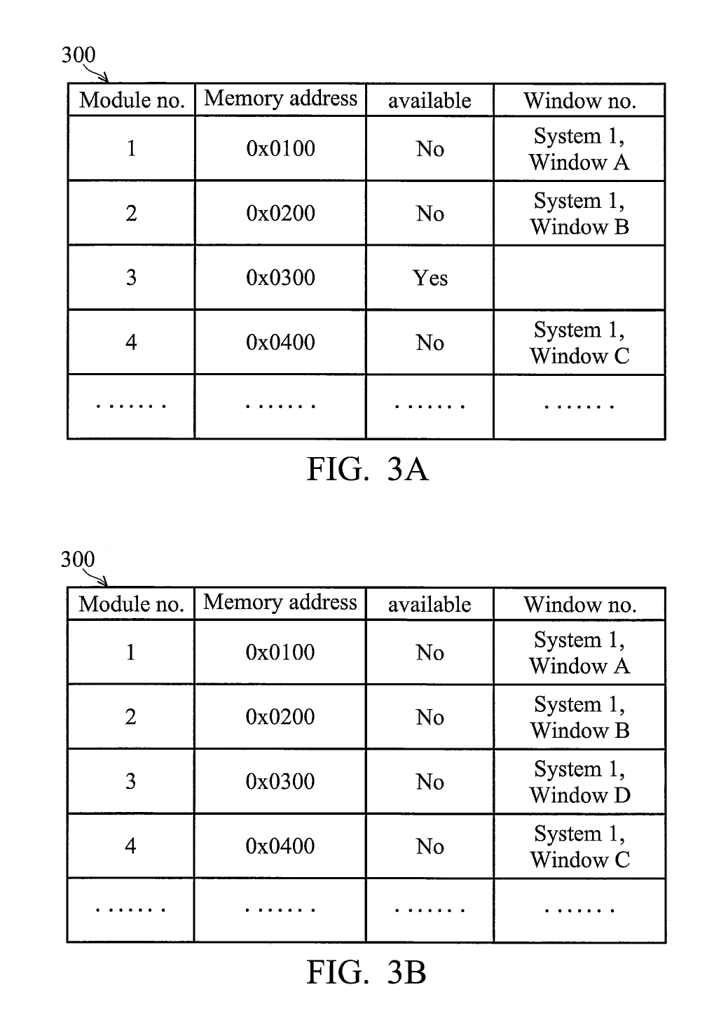

FIG. 3A illustrates an embodiment of a look-up table 300 used by the window location system 180 of the invention. Because the module size of the shared-memory 130 may be determined in advance, the memory address of each module may also be known and calculated. Therefore, the look-up table 300 may be used to record a mapping relationship between each window and its corresponding location (i.e., the memory address) in the shared-memory. As shown in FIG. 3A, the look-up table 300 has recorded several items and each item at least comprises a “Module no.” field, a “Memory address” field, an “available” field and a “Window no.” field. The “Module no.” field represents the number of the module, the “Memory address” field represents the memory address in the shared memory 130 for the module, the “available” field is an available flag indicating whether the module is available or being used in which “Yes” represents that the module is available and can be used to store data while “No” represents that the module is being used and can not be used to store data. The “Window no.” field represents the content of the window data stored therein. For example, referring to the first item of FIG. 3A, it represents that window A of the system 1 is recorded in memory module 1 at memory address 0x0100. If any new window is created, the window location system 180 may find an available module having an available flag set to “Yes” in the table 300 and update content of the located memory module in the table 300. Thereafter, the window data of the newly generated window may be stored into the located memory module. As an example, assume that three windows A, B and C created by the master or slave computer device are currently recorded in the table 300 in which window data of windows A, B and C have been stored in modules 1, 2 and 4, respectively. If a new window “window D” is created on the at least one slave computer device, an available module in the shared memory 130 may be located by the window location system 180 for storing the window data of window D therein. As shown in FIG. 3A, module 3 is represented as being an available module, as such, the window data of the window D will be stored in the module 3 and the available flag will be modified to “No” as shown in FIG. 3B. Therefore, the at least one slave computer device 120 may then write updated window data of window D into the module 3 and the master computer device 110 may read the window data therefrom to obtain the latest window data of window D.

The display system 100 of the invention may further provide a user interface for activating specific applications on both the master and slave computer devices.

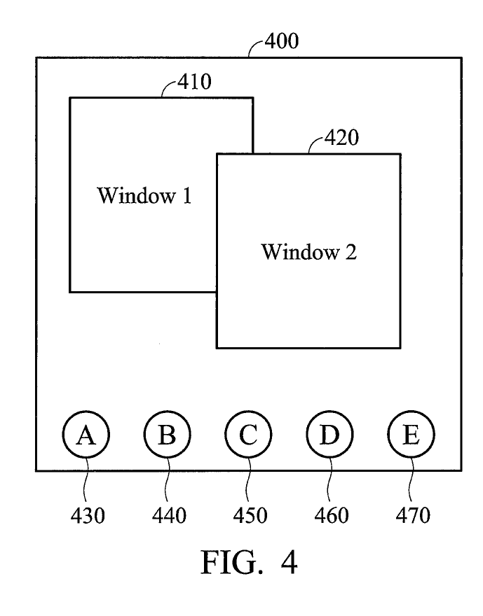

Referring to FIG. 4, which illustrates an embodiment of a user interface of the invention which is a desktop 400 with some clickable links (e.g., icons, buttons) and windows. As shown in FIG. 4, the desktop 400 represents the desktop of a master computer device 100 and the desktop 400 includes two simultaneously displayed windows 410 and 420 and icons 430-470. In this embodiment, icons 430-450 are predefined as icons which perform specific applications running on the master computer device 110 while icons 460-470 are predefined as icons which activate specific applications running on the at least one slave computer device 120. Once the icon 460 has been clicked or pressed by users, an activation signal for activating an application on the at least one slave computer device 120, indicated by the icon 460, will be generated by the master computer device 110. Next, the activation signal will be sent to the at least one slave computer device 120 via the connection interface. After receiving the activation signal, the at least one slave computer device 120 will activate the application and create a window corresponding thereto. The at least one slave computer device 120 will put the resulting window data into the shared-memory 130 where the master computer device 110 can read the window data. Then, the window system 114 of the master computer device 110 may compose the window on the desktop.

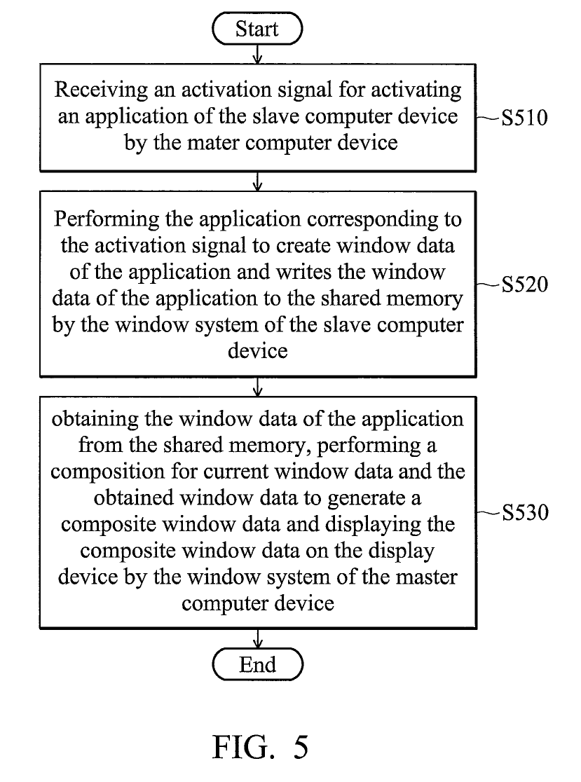

FIG. 5 is a flowchart of an embodiment of a display method for activating an application running on the at least one slave computer device by the master computer device of the invention. Each of the master and slave computer devices comprises a corresponding window system. In this embodiment, the master and slave computer devices are computer devices with homogeneous or heterogeneous architectures belonging to the same desktop or laptop platform. As shown in FIG. 5, a user may press a button 470 on the desktop 400 of the computer device 110 shown in FIG. 4 to activate an application of the at least one slave computer device 120 such that an activation signal will be generated. Therefore, the mater computer device 110 (i.e., the first computer device) upon receiving the activation signal will activate an application of the at least one slave computer device 120 (i.e., the second computer device) (step S510). The master computer device 100 may then pass the activation signal to the at least one slave computer device via the connection interface. After receiving the activation signal, the window system 124 of the at least one slave computer device 120 performs the application corresponding to the activation signal to create window data of the application and writes the window data of the application to the shared memory 130 (step S520). Thereafter, the window system 114 of the master computer device 110 obtains the window data of the application from the shared memory 130, performs a composition for a current window data and the obtained window data to generate a composite window data and displays the composite window data on the display device 140 (step S530).

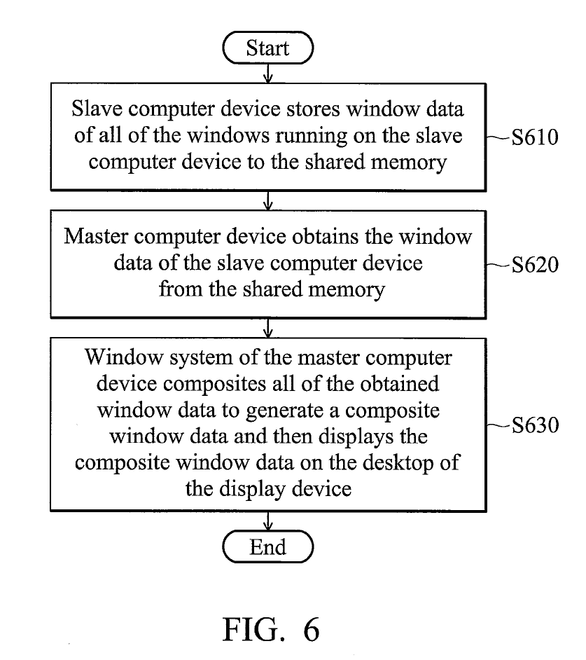

FIG. 6 is a flowchart of another embodiment of a display method for displaying multiple windows simultaneously generated by the master computer device and the at least one slave computer device in a display device of a display system (e.g., the display system 100 shown in FIG. 1) of the invention. First, in step S610, the at least one slave computer device 120 stores window data of all of the windows running on the at least one slave computer device 120 to the shared memory 130. Thereafter, in step S620, the master computer device 110 obtains the window data of the at least one slave computer device 120 from the shared memory 130. The master computer device 110 may utilize the windows location system and look-up table of the invention to obtain the window data of the at least one slave computer device 120 from the shared memory 130.

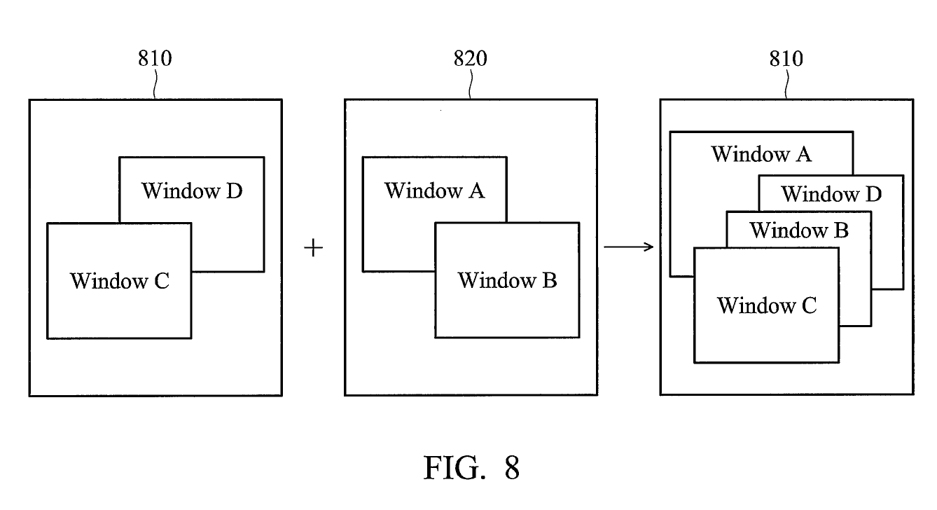

After all of the window data of the at least one slave computer device 120 have been obtained, in step S630, the window system 114 of the master computer device 110 composes all of the obtained window data to generate a composite window data and then displays the composite window data on the desktop of the display device 140. For example, please refer to FIG. 8.

FIG. 8 is a schematic diagram illustrating an embodiment of a window composition operation of the invention. As shown in FIG. 8, Window C and Window D are presented on a desktop 810 of the master computer device 110 and Window A and Window B are presented on a desktop 820 of the slave computer device 120 in which Window A is displayed under Window B. The window system 124 of the slave computer device 120 may maintain positions and z-indexes of windows currently activated in the slave computer device 120 in which the z-indexes represent a layer relationship between the activated windows, e.g., whether one window is displayed under or above another. The window system 124 of the slave computer device 120 may also write indexing information regarding the positions and z-indexes of windows to the shared memory. Therefore, by obtaining the positions and z-indexes of Window A and Window B, the window system 114 of the master computer device 110 will maintain the positions and layer relationship for the obtained window data. That is, Window A is still displayed under Window B, using the indexing information. In addition, the window system 114 of the master computer device 110 will rearrange the obtained window data and its own window data for Window C and Window D to generate a composite window data on the desktop 810 of the master computer device 110 (as shown in the right side of FIG. 8). Thus, the desktop of the display device 140 will display not only the window data of the windows currently running on the master computer device 110 but also window data created by all of the activated applications running on the at least one slave computer device 120.

As the shared memory 130 may be simultaneously accessed by both the master computer device 110 and the at least one slave computer device 120, it is possible that a memory module being written by the at least one slave computer device 120 will be read by the master computer device 110 at the same time and as a result the read window data of the memory module may be incorrect. To avoid this problem, a synchronization method for accessing the shared memory is further provided.

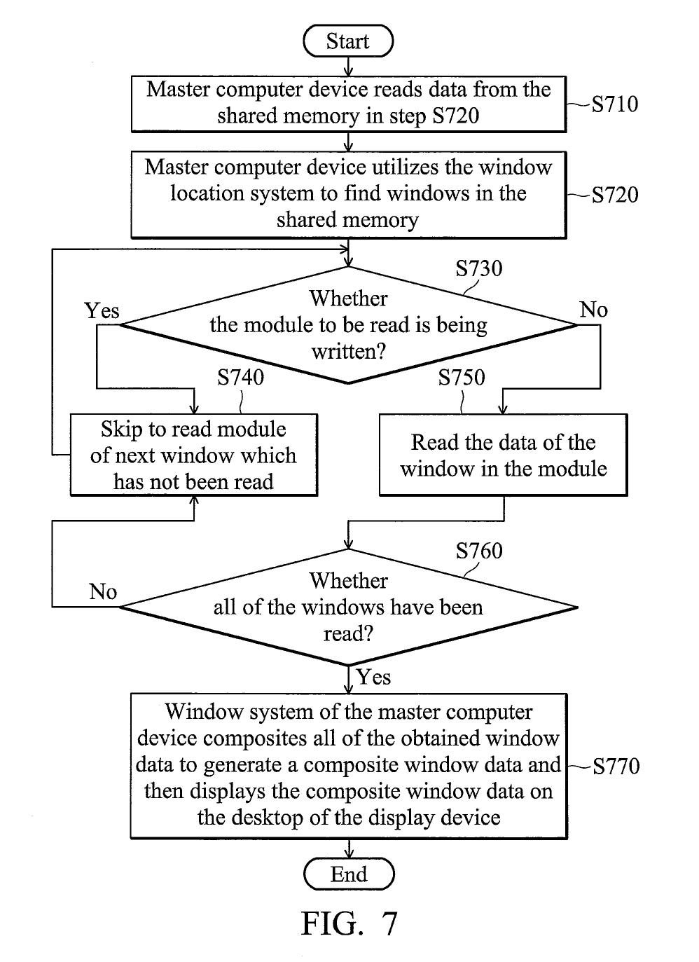

FIG. 7 is a flowchart illustrating an embodiment of a method for accessing the shared memory for the master computer device of the invention. In step S710, the master computer device 110 reads the data from the shared memory 130 and utilizes the window location system 180 to find windows in the shared memory 130 in step S720. In step S730, it is determined whether the module to be read is being written. If so, in step S740, reading of data of the window in the module to be read is skipped and the module of next window which has not been read is read and then step S730 is again performed. If it is determined that the module to be read is not being written (No in step S730), in step S750, the data of the window in the module is read. It is then determined, in step S760, whether all of the windows have been read. If not, then it means that some memory modules have been previously skipped and need to be re-checked. Thus, the steps return to steps S730-S740 to check whether the module of the skipped window is available. If the module of the skipped window is available, step S750 is further performed to read the data of the window in the module. When window data of all of the windows have been read, i.e. no skipped window is presented (Yes in step S760), in step S770, the window system 114 of the master computer device 110 composes all of the obtained window data to generate a composite window data and then displays the composite window data on the desktop of the display device 140 to end the process. When window data of all of the windows other than the skipped window have been read and the skipped window is still being written, the master computer device 110 waits until the writing procedure is completed. Therefore, the maximum waiting time to wait for writing data into the shared-memory 130 is no greater than the time to write a full screen window into the shared-memory 130. Therefore, the shared memory 130 may support simultaneous reading and writing of window data of multiple windows without write/write or read/write conflicts, while incurring a delay before a read or write operation no greater than the maximum time required to write or read the data of a window, respectively.

It is to be noted that, for explanation, only one slave computer device (i.e. the computer device 120) is included in the display system 100 in the above embodiments, but the invention is not limited thereto. In other words, more than one slave system can be included in the display system 100 and connected to the shared memory 130 such that the slave systems may write their own window data to the shared memory 130 and the master computer device 110 may apply the aforementioned display method to display multiple windows simultaneously generated by the master computer device 110 and all other slave computer devices in the display device 140 of the display system 100.

In summary, according to the display system and the display method of the invention, by accessing window data in the shared memory, multiple windows simultaneously generated by multiple computer devices on the same platform, can be quickly displayed in a single display device of the display system without utilizing additional hardware resources such as CPU resources, thus providing efficient and immediate window displaying whenever a window is updated or created. Moreover, users can operate or select applications and/or windows between different computer devices in a single displayed desktop of a single system without being effected from using different operating systems.

Systems and display methods thereof, or certain aspects or portions thereof, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention (e.g., use a ring buffer). Therefore, the scope of the present invention shall be defined and protected by the following claims and their equivalents.

What is claimed is:

1. A display system for simultaneously displaying multiple windows, comprising:
a master computer device with a display device and a corresponding window system;
at least one slave computer device with a corresponding window system;
a shared memory coupled to the master computer device and the at least one slave computer device;
an input means, receiving multiple windows simultaneously generated by the window systems of the master computer device and the at least one slave computer device; and
an output means, displaying the multiple windows on the display device of the master computer device,
wherein the master computer device and the at least one slave computer device simultaneously read window data from and/or write window data into the shared memory.

2. The display system of claim 1, wherein the shared memory further supports simultaneous reading and writing of window data of multiple windows without write/write or read/write conflicts, while incurring a delay before a read or write operation no greater than the maximum time required to write or read the data of a window, respectively.

3. The display system of claim 1, wherein the shared memory further comprises a number of memory modules, each with a corresponding controller.

4. The display system of claim 3, wherein the shared memory is a set of linked memory modules together with a management system for identifying the next memory module to write or read.

5. The display system of claim 3, wherein the shared memory is further associated with a window location system which maps a given window to the memory address of the memory module containing the data of the window.

6. The display system of claim 3, wherein the size of each memory module is determined by the maximum data size of a window used in the window systems.

7. The display system of claim 1, wherein a processing unit type of the master computer device is different from that of the at least one slave computer device.

8. The display system of claim 1, wherein a type of the window system of the master computer device is different from that of the at least one slave computer device.

9. The display system of claim 1, wherein the master computer device and the at least one slave computer device are homogeneous or heterogeneous computer devices belong to the same desktop or laptop platform.

10. A display method for simultaneously displaying multiple windows generated by a master computer device and at least one slave computer device within a display system, wherein the display system includes the master computer device with a display device and a window system, the at least one slave computer device with a window system, and a shared memory accessible by the master computer device and the at least one slave computer device, the method comprising:
storing window data of the at least one slave computer device in the shared memory;
obtaining, by the master computer device, the window data of the at least one slave computer device from the shared memory; and
using the obtained window data to generate a composite window data, wherein the composite window data is displayed on the display device by the master computer device.

11. The display method of claim 10, wherein the shared memory further supports simultaneous reading and writing of window data of multiple windows without write/write or read/write conflicts, while incurring a delay before a read or write operation no greater than the maximum time required to write or read the data of a window, respectively.

12. The display method of claim 10, wherein the shared memory further comprises a number of memory modules, each with a corresponding controller, and the step of storing window data of the at least one slave computer device in the shared memory further comprises:
mapping each window of the at least one slave computer device to a corresponding memory module among the memory modules; and
storing the data of a window of the at least one slave computer device in the corresponding memory module when the window data has been updated.

13. The display method of claim 12, wherein the shared memory is a set of linked memory modules with a management system for identifying the next memory module to write or read.

14. The display method of claim 12, wherein the shared memory is further associated with a window location system which maps a given window to the memory address of the memory module containing the data of the window and the step of obtaining the window data of the slave system from the shared memory by the master computer device further comprises:
utilizing the window location system to find all of the window data of the at least one slave computer device stored in the shared memory; and
reading each of the located window data from the corresponding memory module indicated by the window location system.

15. The display method of claim 14, further comprising:
skipping reading of a current memory module to read another memory module when the current memory module is being written by the at least one slave computer device; and
checking whether the skipped memory module is available after all of the memory modules other than the skipped memory module have been read or skipped,
wherein the master computer device further waits if the skipped memory module is still being written after all of the memory modules other than the skipped memory module have been read or skipped.

16. The display method of claim 10, wherein the size of each memory module is determined by the maximum data size of a window used in the window systems.

17. The display method of claim 10, wherein a processing unit type of the master computer device is different from that of the at least one slave computer device.

18. The display method of claim 10, wherein a type of the window system of the master computer device is different from that of the at least one slave computer device.

19. The display method of claim 10, wherein the master computer device and the at least one slave computer device are homogeneous or heterogeneous computer devices belong to the same desktop or laptop platform.

20. A display method for simultaneously displaying multiple windows in a display system comprising a master computer device with a display device and a corresponding window system, at least one slave computer device with a corresponding window system and a shared memory, comprising:
receiving, by the master computer device, an activation signal for activating an application of the at least one slave computer device;
performing the application to create window data of the application, wherein the window data of the application is written to the shared memory by the window system of the at least one slave computer device; and
obtaining the window data of the application from the shared memory, performing a composition for a current window data and the obtained window data to generate a composite window data, wherein the composite window data is displayed on the display device by the window system of the master computer device.

21. The display method of claim 20, wherein the activation signal for activating an application of the at least one slave computer device is generated by pressing a predetermined clickable link corresponding to the application on a desktop of the master computer device.

22. The display method of claim 20, wherein the shared memory further comprise a number of memory modules, each with a corresponding controller, and the method further comprises the step of:
storing the data of a window of the application in a corresponding memory module when the window data of the application running on the at least one slave computer device has been updated.

23. The display method of claim 20, wherein the shared memory further supports simultaneous reading and writing of window data of multiple windows without write/write or read/write conflicts, while incurring a delay before a read or write operation no greater than the maximum time required to write or read the data of a window, respectively.
